(19) United States
(12) Patent Application Publication
(10) Pub. No.: US 2023/0139614 A1
(43) Pub. Date: May 4, 2023

(54) EFFICIENT COMPUTATION OF MAXIMUM PROBABILITY LABEL ASSIGNMENTS FOR SEQUENCES OF WEB ELEMENTS

(71) Applicant: Klarna Bank AB, Stockholm (SE)

(72) Inventors: Riccardo Sven Risuleo, Stockholm (SE); David Buezas, Berlin (DE)

(21) Appl. No.: 17/967,824

(22) Filed: Oct. 17, 2022

Related U.S. Application Data
(60) Provisional application No. 63/273,822, filed on Oct. 29, 2021.
(60) Provisional application No. 63/273,824, filed on Oct. 29, 2021.
(60) Provisional application No. 63/273,852, filed on Oct. 29, 2021.

(51) Int. Cl. G06F 40/174; G06F 40/143

(52) U.S. Cl. CPC G06F 40/174; G06F 40/143

(57) ABSTRACT

A sequence of interface elements in an interface is determined, where the sequence includes a first element that immediately precedes a second element in the sequence. A first set of potential classifications for the first element is obtained. A set of local confidence scores for a second set of potential classifications of the second element is obtained. A set of sequence confidence scores is obtained by obtaining, for each second potential classification of the second set of potential classifications, a set of scores indicating probability of the second potential classification being immediately preceded in sequence by each first potential classification of the first set of potential classifications. A classification assignment for the second element is determined based on the set of local confidence scores of the first element and the set of sequence confidence scores. An operation is performed with the second element in accordance with the classification assignment.

### CROSS REFERENCE TO RELATED APPLICATION

This application claims the benefit of U.S. Provisional Patent Application No. 63/273,822, filed Oct. 29, 2021, entitled “SYSTEM FOR IDENTIFICATION OF WEB ELEMENTS IN FORMS ON WEB PAGES,” U.S. Provisional Patent Application No. 63/273,824, filed Oct. 29, 2021, entitled “METHOD FOR VALIDATING AN ASSIGNMENT OF LABELS TO ORDERED SEQUENCES OF WEB ELEMENTS IN A WEB PAGE,” and U.S. Provisional Patent Application No. 63/273,852, filed Oct. 29, 2021, entitled “EFFICIENT COMPUTATION OF MAXIMUM PROBABILITY LABEL ASSIGNMENTS FOR SEQUENCES OF WEB ELEMENTS,” the disclosures of which are herein incorporated by reference in their entirety.

This application incorporates by reference for all purposes the full disclosure of co-pending U.S. patent application Ser. No. ______, filed concurrently herewith, entitled “SYSTEM FOR IDENTIFICATION OF WEB ELEMENTS IN FORMS ON WEB PAGES” (Attorney Docket No. 0101560-023US0), and co-pending U.S. patent application Ser. No. ______, filed concurrently herewith, entitled “A METHOD FOR VALIDATING AN ASSIGNMENT OF LABELS TO ORDERED SEQUENCES OF WEB ELEMENTS IN A WEB PAGE” (Attorney Docket No. 0101560-024US0).

### BACKGROUND

Automatic form filling is an attractive way of improving a user's experience while using an electronic form. Filling in the same information, such as name, email address, phone number, age, credit card information, and so on, in different forms on different web sites over and over again can be quite tedious and annoying. Forcing users to complete forms manually can result in users giving up in frustration or weariness and failing to complete their registration or transaction.

Saving once filled in form information for reusing it later when new forms are encountered on newly visited websites, however, presents its own set of problems. Since websites are built in numerous different ways (e.g., using assorted web frameworks), it is difficult to automatically identify the field classes in order to map the fields to the correct form information for that field class. Furthermore, some websites take measures to actively confuse browsers so they do not memorize entered data. For instance, a form-filling system needs to detect whether a web page includes forms, identify the kind of form-fields within it, and decide on the information (from the previously filled in and stored list) that should be provided. However, these all look different depending on the information required from the user, the web frameworks used, and the particular decisions taken by its implementers.

### BRIEF DESCRIPTION OF THE DRAWINGS

Various techniques will be described with reference to the drawings, in which:

FIG. 1 illustrates an example of form-filling system in accordance with an embodiment;

FIG. 2 is a transition diagram for a Hidden Markov Model that models a sequence of elements in accordance with an embodiment;

FIG. 3 illustrates an example of a form usable in accordance with an embodiment;

FIG. 4 illustrates an example of element class prediction in accordance with an embodiment;

FIGS. 5A-5E illustrate a process of element class prediction in accordance with an embodiment;

FIG. 6 illustrates the results of a process of element class prediction in accordance with an embodiment;

FIG. 7 illustrates an example of correcting predictions of element classes in accordance with an embodiment;

FIG. 8 is a flowchart that illustrates an example of element classification in accordance with an embodiment;

FIG. 9 is a flowchart that illustrates an example of classification correction in accordance with an embodiment; and

FIG. 10 illustrates a computing device that may be used in accordance with at least one embodiment.

### DETAILED DESCRIPTION

Techniques and systems described below relate to solutions for problems of efficiently finding a most likely assignment of labels for input elements in a form. In one example, a sequence of form elements in the web page is determined based on a document object model (DOM) of a web page, with the sequence including a first form element that immediately precedes a second form element in the sequence. In the example, a first set of potential classifications for the first form element is obtained. Further in the example, a set of local confidence scores for a second set of potential classifications of the second form element is obtained, with the set of confidence scores being based on one or more features of the second form element. Still further in the example, a set of sequence confidence scores is obtained by, for each second potential classification of the second set of potential classifications, obtaining confidence scores indicating a probability of the second potential classification being immediately preceded in sequence by each first potential classification of the first set of potential classifications. Next in the example, a classification assignment for the second form element is determined based on the set of local confidence scores of the first form element and the set of sequence confidence scores. Finally, in the example, the second form element is filled in accordance with the classification assignment.

In an embodiment, the system of the present disclosure receives a set of predictions for classes of elements of interest, such as form-fields, in an interface that in some embodiments includes a form. If the form elements have been evaluated in isolation, various mistakes can occur; such as multiple fields predicted to be the same element class (e.g., two fields identified as “first name” fields, etc.) or improbable sequences of form elements (e.g., surnames preceding a first name, a zip code following a telephone number field, a telephone number field preceding an address field, a password field following a middle initial field, etc.). Form-fields tend to be ordered in a sequence that humans are used to, and consequently the system of the present disclosure utilizes information based on observed sequences of actual form-fields to determine whether form-field predictions are likely correct or not. For example, give a prediction of a surname field followed by a first name field, the system of the present disclosure may compute a probability of those fields appearing in that sequence based on the sequences of fields in all of the forms it has observed in training data. In this manner, where there is some uncertainty about the element class based on its local characteristics, using information about the likely element class of a previous element can shift the estimate (e.g., to more solidly support a first estimate or switch to a next most-likely estimate). In an example, after evaluating the local features of a current field, the system determines that its most probable element class is a zip code field, and the next most-likely element class is a surname field. If the previous element was determined likely to be a first name field, this may cause the system to shift its prediction for the current field to favor it being a surname field, because surnames may have been observed in the training data to frequently follow first name fields. On the other hand, if the previous element was determined likely to be a state field, this finding may reinforce the probability of the field being a zip code field since zip code fields may have been observed in the training data to frequently follow state fields.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially the field of electronic form filling, by reducing the complexity of computation of the most accurate form element labeling, which allows computation of the most likely labeling to be performed in linear time given the number of elements in the sequence. Additionally, techniques described and suggested in the present disclosure improve the efficiency of electronic form filling and improving user experience by enabling users to quickly complete and submit electronic forms with minimal user input. Moreover, techniques described and suggested in the present disclosure are necessarily rooted in computer technology in order to overcome problems specifically arising with identifying form elements based on their individual features by calculating a probability of the form element identifications being correct based on their sequence in a manner that scales linearly, rather than exponentially, based on the number of elements in the sequence.

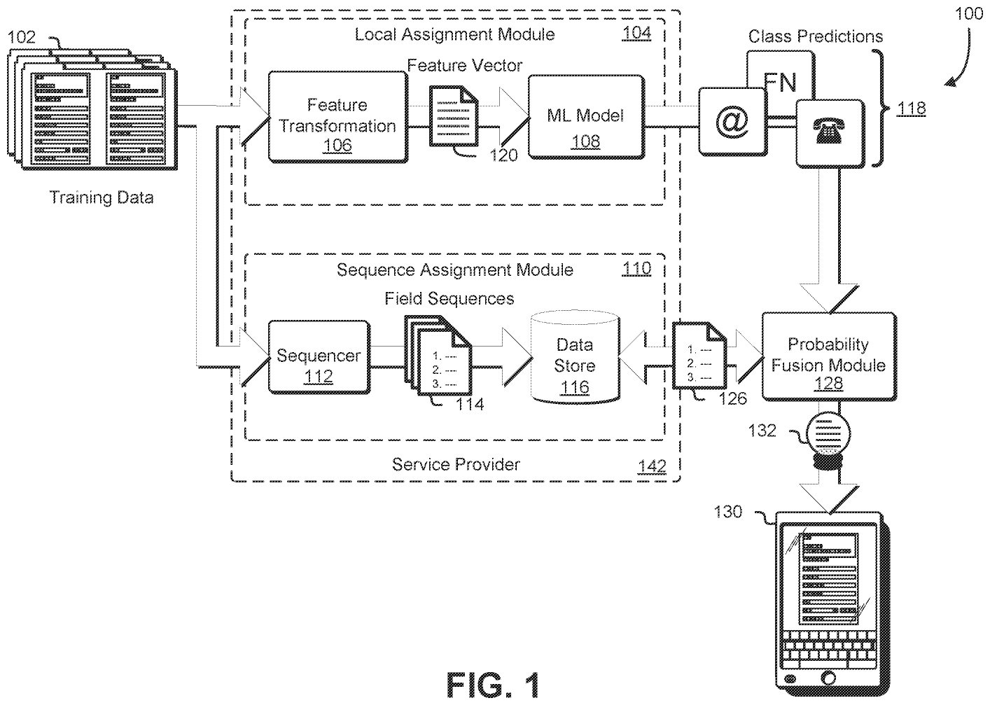

FIG. 1 illustrates an example embodiment 100 of the present disclosure. Specifically, FIG. 1 depicts a system whereby a set of training data 102 is used to train a machine learning model 108 of a local assignment module 104. The training data 102 may be provided to a feature transformation submodule 106 that transforms the training data 102 into feature vectors 120, which may be used to train the machine learning model 108 to produce class predictions 118 based on field features. The training data 102 may also be provided to a sequence assignment module 110; for example, the training data 102 may be provided to a sequencer 112 module which identifies the field sequences 114 of fields in each form of the training data 102. The sequences may be stored in the data store 116 whereby they may be retrieved later by the sequence assignment module 110 in determination of sequence confidence scores 126 for a particular form being analyzed. For a particular form being analyzed, the class predictions 118 of the form-fields as output from the local assignment module 104 and the sequence confidence scores 126 may be input to a probability fusion module 128, which may output a classification assignment 132 for form filling.

In embodiments of the present disclosure, the system combines information of each element (i.e., the local features) in an interface together with the sequencing information about element ordering to provide an improved estimate of the probability of any label assignment. The system may be comprised of three components/modules, the local assignment module 104, the sequence assignment module 110 and the probability fusion module 128.

The local assignment module 104 may be a hardware or software module that obtains information about elements of interest as inputs, and, in return, outputs the confidence scores for the elements belonging to a class from a predefined vocabulary of classes. In embodiments, the local assignment module 104 is similar to the local assignment module described in U.S. patent application Ser. No. ______, entitled “SYSTEM FOR IDENTIFICATION OF WEB ELEMENTS IN FORMS ON WEB PAGES” (Attorney Docket No. 0101560-023US0), incorporated herein by reference.

The local assignment module 104 may be trained in a supervised manner to, for an element of interest, return confidence scores for the element belonging to each class of interest from predefined classes of interest (e.g., name field, zip code field, city field, etc.) based on the information about element of interest (e.g., a tag, attributes, text contained within the element source code and immediate neighboring text elements, etc.). In some examples, an “element of interest” refers to an element of an interface that is identified as having potential to be an element that falls within a class of interest. In some examples, an “element” refers to an object incorporated into an interface, such as a HyperText Markup Language (HTML) element.

Examples of elements of interest include HTML form elements, list elements, or other HTML elements, or other objects occurring within an interface. In some examples, a “class of interest” refers to a particular class of element that an embodiment of the present disclosure is trained or being trained to identify. Examples of classes of interest include name fields (e.g., first name, middle name, last name, etc.), surname fields, cart button, total amount field, list item element, or whatever element is suitable to use with the techniques of the present disclosure as appropriate to the implemented embodiment. Further details about the local assignment module may be found in U.S. patent application Ser. No. ______, entitled “SYSTEM FOR IDENTIFICATION OF WEB ELEMENTS IN FORMS ON WEB PAGES” (Attorney Docket No. 0101560-023US0), incorporated herein by reference. Information about the element of interest may include tags, attributes, or text contained within the source code of the element interest. Information about the element of interest may further include tags, attributes, or text contained within neighboring elements of the element of interest.

The sequence assignment module 110 may be a hardware or software module that obtains information about the ordering (i.e., sequence) of elements of interest and may use this sequencing information from the ordering of fields to output the probability of each element of interest belonging to each of the predefined classes of interest. The field ordering may be left-to-right ordering in a rendered web page or a depth-first traversal of a DOM tree of the web page; however, it is contemplated that the techniques described in the present disclosure may be applied to other orderings (e.g., top-to-bottom, right-to-left, pixel-wise, largest-to-smallest, smallest-to-largest, etc.) as needed for the region or particular implementation of the system. The sequence assignment module 110 may be similar to the sequence assignment module described in U.S. patent application Ser. No. ______, entitled “A METHOD FOR VALIDATING AN ASSIGNMENT OF LABELS TO ORDERED SEQUENCES OF HTML ELEMENTS IN A WEB PAGE” (Attorney Docket No. 0101560-024US0), incorporated herein by reference.

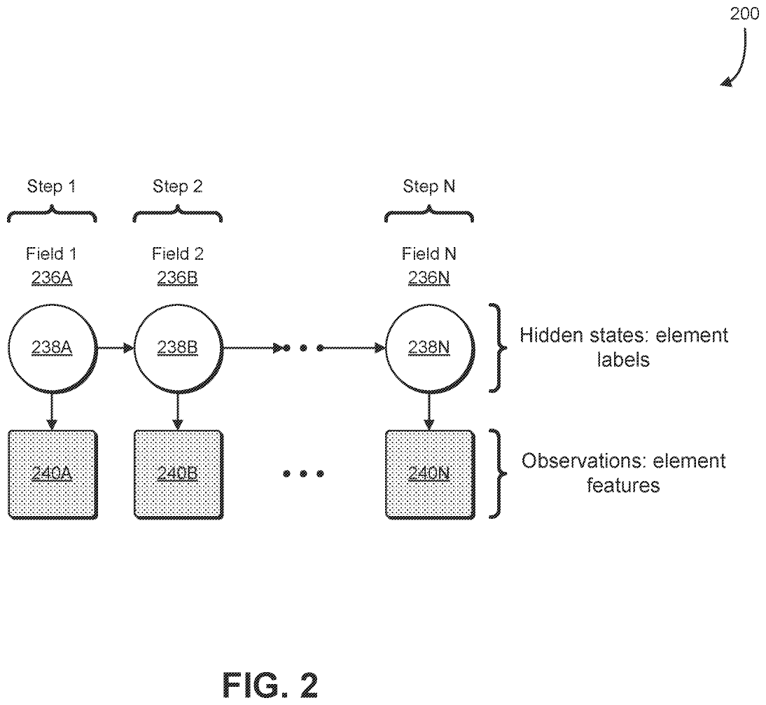

The probability produced by the sequence assignment module 110 may reflect the probability of the predicted elements being correct based on a frequency that such elements have been observed to occur in that order in the set of training data 102. For example, if the local assignment module 104 outputs the class predictions 118 that predict elements of first name, surname, password, shipping address, in that order, in an interface, the sequence assignment module 110 may receive that ordering information as input, and, in return, output a value reflecting the frequency of those elements occurring in that order in the set of training data 102. The higher the frequency, the more likely the class predictions are to be correct. Further details about the sequence assignment module may be found in the description of FIG. 2.

In an example, suppose that the local assignment module 104 and the sequence assignment module 110 have been trained, and we want to find the probability of any possible assignment of labels [lab₁, lab_{M}] from a vocabulary of possible classes [cls₁, cls_{K}] that the system was trained on given a new sequence of elements [el₁, . . . , el_{M}]. In the example, the local assignment module 104 returns a table of confidence scores p(labⱼ|elᵢ) for possible class labels for each element in the sequence. In some embodiments, the confidence scores are probabilities between 0 and 1 (1 being 100%). In some examples, a “label” refers to an item being predicted by a machine learning model or the item the machine learning model is being trained to predict (e.g., a y variable in a linear regression). In some examples, a “feature” refers an input value derived from a property (also referred to as an attribute) of data being evaluated by a machine learning model or being used to train the machine learning model (e.g., an x variable in a linear regression). A set of features corresponding to a single label may be stored in one of many columns of each record of a training set, such as in rows and columns of a data table. In the example, the sequence assignment module 110 returns a table of confidence scores p(labᵢ|lab_{0 . . . i-1}) of possible class labels for each element, given the labels of the elements above.

Then, in the example, the probability fusion module combines the two probabilistic predictions and returns a probability of the full assignment, for example, using Bayes' theorem:

$$p ( {lab}_{1} , … , {lab}_{M} \vert {el}_{1} , … , {el}_{M} ) = \frac{\begin{matrix}p ( {el}_{M} \vert {lab}_{M} ) … p ( {el}_{2} \vert {lab}_{2} ) p ( {el}_{1} \vert {lab}_{1} ) \times \\ p ( {lab}_{M} \vert {lab}_{0 : M - 1} ) … p ( {lab}_{2} \vert {lab}_{1} ) p ( {lab}_{1} \vert start )\end{matrix}}{K}$$

Thus, using the system of the present disclosure, probability of any possible assignment of class labels to a sequence of elements can be evaluated in real-time time according to the values returned by the two modules.

The probability fusion module 128 may “fuse” the two probability assignments output (e.g., from the local assignment module 104 and the sequence assignment module 110) together to compute the full probability of every possible assignment of all the fields in the set. In some embodiments, the probability fusion module 128 makes a final prediction of a class of interest for each element of interest, based on the class prediction for the element by the local assignment module 104 and the probability of the predicted class following the predicted class of the previous element of interest in the sequence. In embodiments, the probability fusion module 128 may make its final prediction by applying Bayes' theorem to the confidence scores from the local assignment module 104 and the sequence assignment module 110 and making a determination based on the resulting value. Further details about the probability fusion module may be found in the descriptions of FIGS. 2-9.

In other embodiments of the probability fusion module 128 of FIG. 1, the probability fusion module 128, the local assignment module 104, and the sequence assignment module 110 described above, which are able, given a set of elements in an interface (e.g., a web page with input fields in a form or list elements in a list) sorted according to a defined ordering (e.g., the left-to-right order in the rendered web page), to return posterior probability scores of the label assignments for the elements in the set. In Bayesian statistics, the posterior probability of a random event or an uncertain proposition is the conditional probability that is assigned after the relevant evidence or background is taken into account. Here, finding the posterior probability enables picking the labeling with the highest probability among all possible label assignments.

In these embodiments, the system is trained on a representative corpus of examples, such as the set of training data 102 of FIG. 1. The sequence assignment module 110 of FIG. 1 may use tables of confidence scores to compute the probability of any possible labeling with a linear-time algorithm. In these embodiments, to implement the linear-time algorithm, the transition probability table is restricted to only include the previous element in the sequence (including a dummy “start” element to indicate the beginning of the sequence). This allows the sequence to be modeled as an HMM where the latent states are the labels of the elements and the observations consist of the local features of each element according to the transition graphical representation in FIG. 2.

The set of training data 102 may include interfaces, such as a set of web pages, which have elements of interest already determined and marked as belonging to a class (e.g., email, password, etc.). The set of training data 102 may then be used to train the local assignment module 104 to identify the classes of elements of interest in interfaces that have not been previously observed by the local assignment module 104. Information in the set of training data 102 about which sequences of the elements were observed together can also be used to train the sequence assignment module 110 to compute the sequence confidence scores 126. For example, if the previous element is an email field, the sequence assignment module 110 may output the probability of a password field being the next element in the sequence, or the probability of a last name field being the next element in the sequence, and so on.

The form-filling process running on the client device 130 may evaluate an interface that it is browsing and, for each element of interest, submit a classifier for the element of interest to the local assignment module 104. In some examples, a “classifier” refers to an algorithm that identifies which of a set of categories an observation belongs to. In some other examples, a “classifier” refers to a mathematical function implemented by a classification algorithm that maps input data to a category. In return, the local assignment module 104 may provide the client device 130 with a list of possible labels (the class predictions 118) that the element of interest could be with their isolated probability of being that label. With that the class predictions 118, in addition to the sequence confidence scores 126, may be inputted to a Viterbi algorithm, from which the most likely assignment (e.g., the assignment that maximizes the full probability) may be extracted.

For example, in an interface on the client device 130, the client device 130 may examine the interface to identify all of the elements of interest in the interface. The client device 130 may further look at the context of each element (e.g., the HTML, properties of the element, classes, and properties of other elements adjacent to or at least near/proximate to the element, etc.) and use this context to generate a feature vector in the manner described in the present disclosure. For a given form element feature vector, the client device 130 may provide the feature vector to the local assignment module 104, and the local assignment module 104 may respond with output indicating that the form element has a 60% probability of being an email, a 30% probability of being a password, and a 10% probability of being a shipping address.

Based on the output, a form element class may be selected and input to the sequence assignment module 110, which may respond with sequence confidence scores 126 of the probability of a succeeding element of interest being the various ones of the possible labels. The probability may be based on relative frequency of different classes of elements of interest occurring in succession in the same interface in the set of training data 102. For example, if the selected form element class is an email field, the sequence confidence scores 126 may indicate that the next element of interest is 50% likely to be a password field. In some embodiments, all confidence scores are non-zero. For example, even in a case where there are 100 million interface pages with email fields in the set of training data 102 and none are observed to have a middle initial field immediately succeeding an email field, such a sequence is theoretically possible. Therefore, this possibility may be accounted for with a smoothing factor, α. Smoothing factor α may be a very small probability, such as

$$\frac{1}{NumObservations + 1} ,$$

which in the example may be 0.0000000099999999. Alternative methods of computing confidence scores of field sequences are contemplated, for example by stepping through each element of interest and maximizing the probability for the element class by determining the best assignment for the element is assuming that the best assignments were made for all previous fields in the sequence.

The training data 102 may be a set of sample web pages, forms, and/or elements (also referred to as interface objects) stored in a data store. For example, each web page of the training data 102 may be stored as a complete page, including their various elements, and each stored element and each web page may be assigned distinct identifiers (IDs). Elements of interest may be identified in the web page and stored separately with a reference to the original web page. The IDs may be used as handles to refer to the elements once they are identified (e.g., by a human operator) as being elements of interest. So, for example, a web page containing a shipping address form may be stored in a record in a data store as an original web page, and the form-fields it contains such as first name, last name, phone number, address line 1, address line 2, city, state, and zip code may be stored in a separate table with a reference to the record of the original web page. If, at a later time, a new element of interest is identified—middle initial field, for example—the new element and the text surrounding it can be retrieved from the original web page and be added in the separate table with the reference to the original web page. In this manner, the original web pages are preserved and can continue to be used even as the elements of interest may evolve. In embodiments, the elements of interest in the training data 102 are identified manually by an operator (e.g., a human).

Once the elements of interest are identified and stored as the training data 102, it may be used by the feature transformation submodule 106 to train the machine learning model 108. The feature transformation submodule 106 may generate/extract a set of features for each of stored elements of interest. The set of features may include attributes of the interface object (e.g., name, value, ID, etc., of the HTML, element) or keywords (also referred to as a “bag of words” or BoW) or other elements near the interface object. For example, text of “CVV” near a form-field may be a feature with a strong correlation to the form-field being a “card verification value” field. Likewise, an image element depicting an envelope icon with a source path containing the word “mail” (e.g., “http://www.example.com/img/src/mail.jpg”) and/or nearby text with an “@” symbol (e.g., “johndoe@example.com”) may be suggestive of the interface object being a form-field for entering an email address. Each interface object may be associated with multiple features that, in conjunction, allow the machine learning model to compute a probability indicating a probability of the interface object being of a certain class (e.g., card verification value field).

The local assignment module 104 may be a classification model implemented in hardware or software capable of producing probabilistic predictions of element classes. Embodiments of this model could include a naive Bayes classifier, neural network, or a softmax regression model. The local assignment module 104 may be trained on a corpus of labeled HTML elements to predict the probability (e.g., p(label|features)) of each HTML element being assigned a given set of labels. These confidence scores may be indicated in the class predictions 118.

The feature transformation submodule 106 may be a submodule of the local assignment module that transforms source data from an interface, such as from the training data 102, into the feature vector 120. In embodiments, the feature transformation submodule 106 may identify, generate, and/or extract features of an interface object, such as from attributes of the object itself or from nearby text or attributes of nearby interface objects as described above. In embodiments, the feature transformation submodule 106 may transform (tokenize) these features into a format suitable for input to the machine learning model 108, such as the feature vector 120. For example, the feature transformation submodule 106 may receive the HTML of the input object, separate the HTML into string of inputs, normalize the casing (e.g., convert to lowercase or uppercase) of the inputs, and/or split the normalized inputs by empty spaces or certain characters (e.g., dashes, commas, semicolons, greater-than and less-than symbols, etc.). These normalized, split inputs may then be compared with a dictionary of keywords known to be associated with elements of interest to generate the feature vector 120. For example, if “LN” (which may have a correlation with “last name” fields) is in the dictionary and in the normalized, split inputs, the feature transformation submodule 106 may append a “1” to the feature vector; if “LN” is not present in the normalized, split inputs, the feature transformation submodule 106 may instead append a “0” to the feature vector, and so on. Additionally or alternatively, the dictionary may include keywords generated according to a moving window of fixed-length characters. For example, “ADDRESS” may be transformed into three-character moving-window keywords of “ADD,” “DDR,” “DRE,” “RES,” and “ESS,” and the presence or absence of these keywords may result in a “1” or “0” appended to the feature vector respectively as described above. Note that “1” indicating presence and “0” indicating absence is arbitrary, and it is contemplated that the system may be just as easily implemented with “0” indicating presence and “1” indicating absence, or implemented using other values as suitable. This tokenized data may be provided as input to the machine learning model 108 in the form of the feature vector 120.

To train the machine learning model 108, the feature transformation submodule 106 may produce a set of feature vectors from the training data 102, as described above. In one embodiment, the feature transformation submodule 106 may first obtain a set of features by extracting a BoW from the interface object (e.g., “bill,” “address,” “pwd,” “zip,” etc.). Additionally or alternatively, in an embodiment, the feature transformation submodule 106 may extract a list of tag attributes from interface objects such as HTML elements (e.g., title=“ . . . ”). Note that certain HTML elements, such as “input” elements, may provide higher accuracy since such input elements are more standardized than other classes of HTML tags. Additionally or alternatively, in an embodiment the feature transformation submodule may extract values of certain attributes. The values of attributes such as minlength and maxlength attributes may be useful in predicting the class of interface object. For example, a form-field with minlength=“5” may be suggestive of a zip code field. As another example, a form-field with a maxlength=“1” may suggest a middle initial field. Thus, some of the features may be visible to the user, whereas other features may not.

Additionally or alternatively, in embodiments, the features are be based on text content of nearby elements (such as those whose tag name is “label”). Additionally or alternatively, in an embodiment, the features are based on the context of the element. For instance, this can be done by adding the text surrounding the HTML element of interest into the feature mixture. Near elements can be determined by virtue of being within a threshold distance to the HTML element of interest in the DOM tree or pixel proximity on the rendered web page. Other embodiments may combine one or more of the methods described above (e.g., BoW, attributes, context text, etc.).

The obtained features may then be transformed into a set of feature vectors as described above, which may be used to train a classifier. For example, each feature vector from the training data 102 may be associated with a label or ground truth value that has been predetermined (e.g., “Shipping—Full Name” field, “Card Verification Value” field, etc.), which may then be specified to the machine learning model 108. In various embodiments, the machine learning model 108 may comprise at least one of a logistic model tree (LMT), a decision tree that decides which features to use, logistic regression, naïve Bayes classifier, a perceptron algorithm, an attention neural network, a support-vector machine, random forest, or some other classifier that receives a set of features, and then outputs confidence scores for a given set of labels.

The sequence assignment module 110 may be a hardware or software module capable of returning a probability of a given sequence of element occurring. The sequence assignment module may, with access to a corpus of sequence data in the data store 116 based on observed sequences of elements in the training data 102, determine the probability of two or more elements occurring in a given order.

The sequencer 112 may, for each interface in the set of training data 102, be hardware or software capable of extracting, from the training data 102, a set of elements in the sequence in which they occur within an interface and store this sequence information in the data store 116. The field sequences 114 may be a sequence information indicating an order of occurrence of a set of elements of an interface in the training data 102.

The data store 116 may be a repository for data objects, such as database records, flat files, and other data objects. Examples of data stores include file systems, relational databases, non-relational databases, object-oriented databases, comma delimited files, and other files. In some implementations, the data store 116 is a distributed data store. The data store 116 may store at least a portion of the set of training data 102 and/or data derived from the set of training data 102, as well as the field sequences 114 of the elements of interest in the set of training data 102.

The feature vector 120 may be a set of numerals derived from features of an element of interest. In some embodiments, the feature vector 120 is a string of binary values indicating the presence or absence of a feature within or near to the element of interest in the DOM tree of the interface. The features of elements of interest in the training data 102 may be transformed into feature vectors, which are used to train the machine learning model 108 to associate features represented in the feature vector 120 with certain labels (e.g., the element of interest class). Once trained, the machine learning model 108 may receive a feature vector derived from an arbitrary element of interest and output a confidence score indicating a probability of the element of interest being of a particular class of element.

The sequence confidence scores 126 may be values indicating the probability of two or more particular elements of interest occurring in order. For example, the sequence assignment module 110 may receive as input information indicating at least two element classes and their sequential order (e.g., first element class followed by second element class), and, based on historical data in the data store 116 derived from the training data 102, may output a value indicating a probability of this occurring based on observed sequences of element classes in the training data 102.

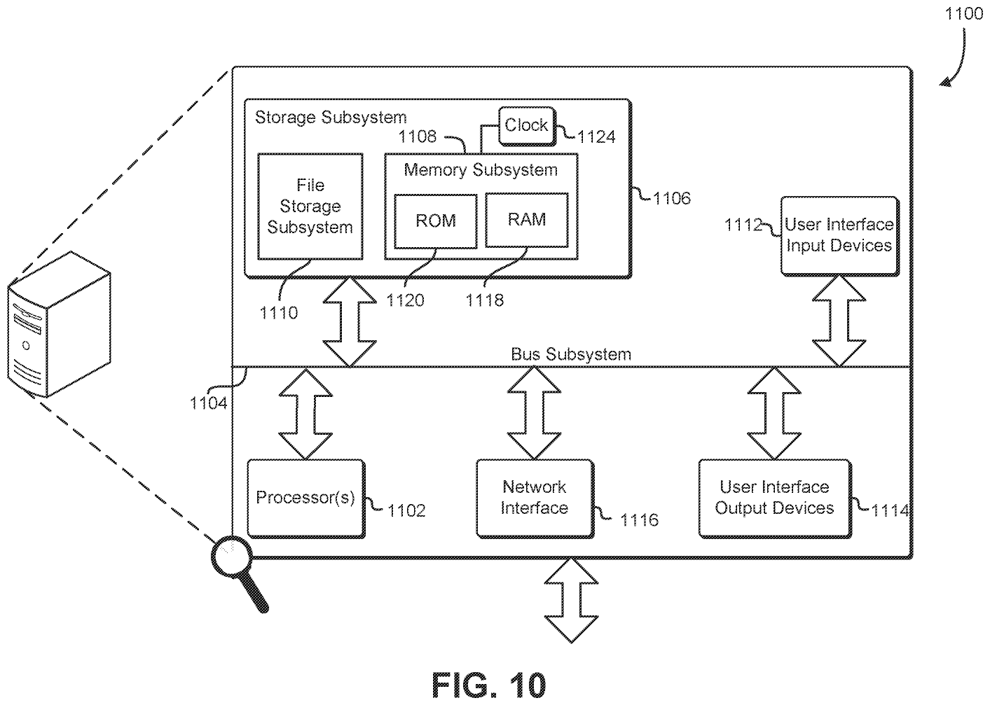

The client device 130, in some embodiments, may be embodied as a physical device and may be able to send and/or receive requests, messages, or information over an appropriate network. Examples of such devices include personal computers, cellular telephones, handheld messaging devices, laptop computers, tablet computing devices, set-top boxes, personal data assistants, embedded computer systems, electronic book readers, and the like, such as the computing device 1000 described in conjunction with FIG. 10. Components used for such a device can depend at least in part upon the class of network and/or environment selected. Protocols and components for communicating via such a network are well known and will not be discussed in detail. Communication over the network can be enabled by wired or wireless connections and combinations thereof. The client device 130 may at least include a display whereby interfaces and elements of interest described in the present disclosure may be displayed to a user.

In embodiments, an application process runs on the client device 130 in a host application (such as within a browser or other application). The application process may monitor an interface for changes and may prompt a user for data to fill recognized forms on the fly. In some embodiments, the application process may require the host application to communicate with a service provider server backend and provide form-fill information, such as user data (e.g., name, address, etc.), in a standardized format. In some embodiments, the application process exposes an initialization function that is called with a hostname-specific set of selectors that indicates elements of interest, fetched by the host application from the service provider server backend. In embodiments, a callback may be executed when form-fields are recognized. The callback may provide the names of recognized input fields as parameters and may expect the user data values to be returned, whereupon the host application may use the user data values as form-fill information to fill out the form. The client device 130 may automatically fill the field with the user's first name (as retrieved from memory or other storage). In some embodiments, the client device 130 asks the user for permission to autofill fields before doing so.

In this manner, techniques described in the present disclosure extend form-filling functionality to unknown forms by identifying input elements within interface forms from the properties of each element and its context within the interface form (e.g., text and other attributes around the element). The properties may be used to generate a dataset based on a cross product of a word and an attribute.

The classification assignment 132 may be a set of final confidence scores of an interface element being particular classes. Based on the classification assignment 132, the client device 130 may assume that elements of interest within an interface correspond to classes indicated by the classification assignment 132. From this assumption, the client device may perform operations in accordance with the classification assignment 132, such as automatically filling a form (e.g., inputting characters into a form element) with user data that corresponds to the indicated element classes. For example, if the classification assignment 132 indicates a field element as being a first name field, the client device 130 may automatically fill the field with the user's first name (as retrieved from memory or other storage). In some embodiments, the client device 130 asks the user for permission to autofill fields before doing so.

The service provider 142 may be an entity that hosts the local assignment module 104 and/or the sequence assignment module 110. The service provider 142 may be a different entity (e.g., third-party entity) from the provider that provides the interface that is autofilled. In some embodiments, the service provider 142 provides the client device 130 with a software application that upon execution by the client device 130, causes the client device 130 to fill in form-fields according to their class in the classification assignment 132. In some embodiments, the application runs as a third-party plug-in/extension of a browser application on the client device 130, where the browser application displays the interface. Although the service provider 142 is depicted as hosting both the local assignment module 104 and the sequence assignment module 110, it is contemplated that, in various embodiments, either or both the local assignment module 104 or the sequence assignment module 110 could be hosted in whole or in part on the client device 130. For example, the client device 130 may submit source code containing elements of interest to the service provider 142, which may transform the source code using the feature transformation submodule 106, and the client device 130 may receive the feature vector 120 in response. The client device 130 may then input the feature vector 120 into its own trained machine learning model to obtain the class predictions 118.

In some embodiments, the services provided by the service provider 142 may include one or more interfaces that enable a user to submit requests via, for example, appropriately configured application programming interface (API) calls to the various services. Subsets of services may have corresponding individual interfaces in addition to, or as an alternative to, a common interface. In addition, each of the services may include one or more service interfaces that enable the services to access each other (e.g., to enable a virtual computer system to store data in or retrieve data from a data storage service). Each of the service interfaces may also provide secured and/or protected access to each other via encryption keys and/or other such secured and/or protected access methods, thereby enabling secure and/or protected access between them. Collections of services operating in concert as a distributed computer system may have a single front-end interface and/or multiple interfaces between the elements of the distributed computer system.

FIG. 2 is a transition diagram 200 for a Hidden Markov Model (HMM) that models a sequence of field elements. The transitions between the hidden states may be given by the probability of label i being succeeded by label j and may be arranged in a table. Each entry of the table may be filled using historical data with the observed frequency of that specific transition:

$$p ( transition i \to j ) = \frac{\# Observed transitions from field i to field j + α}{\# Transitions starting from field i + α \cdot Total \# of fields} ,$$

Where α is a smoothing factor that accounts for possibly unobserved transitions. With α>0, the small probability of field transitions has never been observed can be accounted for that would otherwise be difficult to predict. Note that the formula for this embodiment differs from the formula in the embodiment described in FIG. 1 in that the transitions in this embodiment are only dependent on the previous element in the sequence, whereas the transitions of the fusion module embodiment of FIG. 1 are dependent upon all elements before the current one.

For the observation probability, any method that is trained to compute a probability may be used; for instance, a naive Bayes model or any other probabilistic model that is able to compute conditional probability p(xᵢ|fⱼ) for some observed features xᵢ in element i and all possible labels fⱼ in the vocabulary of labels. Once the probability and the transition confidence scores are computed, the Viterbi algorithm may be utilized to compute the maximum a posteriori assignment of labels of the sequence:

ω(fₙ)=max_{f}_{₁} _{. . . f}_{ₙ₋₁}p(f₁ . . . fₙ|x₁ . . . xₙ)

ω(fₙ₊₁)=log p(xₙ₊₁|fₙ₊₁)+max_{fn}(log p(fₙ₊₁|fₙ)+ω(fₙ)

where ω represents the maximum probability over all possible immediately preceding elements for each label at each step in the sequence. This dynamic programming recursion may be initialized at the first element using ω(f₁)=log p(f₁|<start>)+log p(x₁|f₁). Note that the recursive form of ω(fₙ) allows the finding of the maximum a posteriori probability estimate in linear time. Once that maximum is found, backtracking (again in linear time) may be used to find all the labels assignments that correspond to the said maximum. Thus, ω(fₙ) describes the probability of each possible label for element n, given that all the previous elements have been labeled with their best options. According to the dynamic programming recursion, the best assignment for this element may be the one that maximizes the probability of this label together with the probability of the best assignment for all previous elements in the sequence.

In addition to this maximum a posteriori assignment for all the elements, similar dynamic programming structures in the HMM graph may be used to compute marginal confidence scores for each element (which serves as a proxy for the confidence of the labeling of the elements themselves), as well as an overall probability score for the sequence (which serves as a proxy for the confidence of the overall labeling). In embodiments, this solution is a linear-time algorithm. This technique has the benefit of increasing the accuracy of the estimate without a substantial increase in processing time.

In FIG. 2, node 238A corresponds to each possible label for first field 236A and node 240A corresponds to features of the first field 236A. Node 238B corresponds to each possible label for second field 236B and node 240B corresponds to features of the second field 236B. Node 238N corresponds to each possible label for final field 236N and node 240N corresponds to features of the final field 236N.

In the transition diagram 200, nodes 240A-40N represent the observed features of the fields 236A-36N, respectively. In the transition diagram 200, the label of the first field 236A influences the label of the second field 236B, which in turn influences the label of the next label in the sequence, and so on until the final field 236N. Thus, the horizontal arrows indicate that probabilistic dependency, and the final field 236N depends on the previous one, and ultimately depends on the first field 236A. This probabilistic dependency may be determined by a sequence assignment module, like the sequence assignment module 110 of FIG. 1.

In embodiments, the system has a vocabulary library of possible features associated with element of interest. For some features, values may be Boolean (e.g., where 1 indicates the field element having the feature and 0 representing the field element not having the feature, or vice versa depending on implementation). In other cases, the feature values may be some other numeric representation (such as X and Y values indicating pixel positions of the element, or maximum/minimum length of the input value of the field element). Stored in a data store, like the data store 116 of FIG. 1, may be a table where the feature values of the various observed elements of a particular class may be stored, and the system can use these stored feature values to determine a most likely element class of an arbitrary element based on its features. For example, for a first class of element, a first feature may be present 30% of the time, a second feature may be present 20% of the time, a third feature may be present 35% of the time, and so on. Thus, based on the presence of features of a given element, a machine learning model may determine the confidence scores of the element being any of the observed element classes. The vertical arrows, thus, may represent the probabilistic dependencies provided by a local assignment module like the local assignment module 104 of FIG. 1.

At Step 1, the choices made have an impact on what is determined to be the best choice at Step 2, which has an impact on what is best at the next step, and so on. Given that there are multiple options for element labels at each of nodes 238A-38N, the maximal probability for the most probable combination of fields and sequence may not be determinable until the last step (Step N). At Step N, there is only one next option, which is “end.” Thus, at Step N, the system of the present disclosure may determine which of the label options, as determined by traversing from Step 1 to Step N is best for node 238N given that node 238N definitively the final node in the sequence. Once the label for node 238N is determined in this manner, the nodes may be traced backwards in the same manner. For example, the system of the present disclosure may determine which of the label options is best for node 238N−1 (not shown) given the label determined for node 238N, and so on back to node 238A.

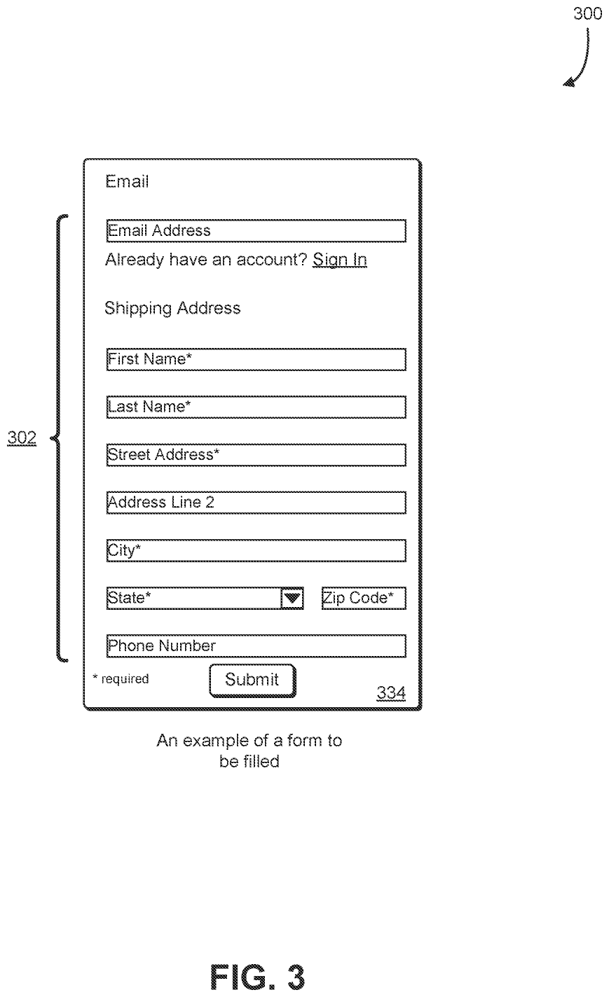

FIG. 3 illustrates an example 300 of a form 334 to be filled in which an embodiment of the present disclosure. As illustrated in FIG. 3, the example 300 depicts an application of the system of the present disclosure to the problem of computing form field labelings for an automatic form-filling system. In this example 300, the elements 302 considered are the HTML INPUT elements in the FORM that need to be filled, and their sequencing is given by the “left-to-right, top-to-bottom” natural visual ordering on the rendered web page.

In the form 334, a baseline form-filling system based on a naive Bayes classifier may output the estimate:

“predictions_naivebayes”: [[“Account—Email”, 1.0], [“First Name”, 1.0], [“Last Name”, 1.0], [“Address”, 0.9999999899054615], [“Address”, 0.9994931948550588], [“City”, 1.0], [“State”, 1.0], [“Zip Code”, 1.0], [“Phone Number”, 1.0]]

Such an estimate may have been output by a local assignment module, such as the local assignment module 104 of FIG. 1 (e.g., the vertical arrows of FIG. 2). Note, in this estimate, the single-field estimator is very confident (˜99.9%) about the fact that the fifth field is an Address field, whereas the correct classification of this field actually is an Address2 field. This is because the local assignment module 104 only looks at elements in isolation and tries to label the elements 302 based on their respective local features (e.g., if field contains the string “Address,” there is a high probability that it is an address field, etc.).

On the same form, however, the form-filling system of the present disclosure may return:

“predictions_viterbi”: [[“Account—Email”, 1.0], [“First Name”, 1.0], [“Last Name”, 1.0], [“Address”, 1.0], [“Address2”, 0.9999955884920374], [“City”, 1.0], [“State”, 1.0], [“Zip Code”, 1.0], [“Phone Number”, 1.0]]

Note the correct prediction of Address2 for the fifth field. This is possible because the system of the present disclosure uses information from the previous field (in this case, Address with very high confidence), together with the fact that Address is more likely to be followed in sequence by Address2 than by another Address to provide a more accurate labeling of the form (e.g., the horizontal arrows from FIG. 2). Note too how, because Address2 is selected for the fifth field, the confidence that the fourth field is an Address field has increased to 1.0. This is because the sequence assignment module, having determined that the fifth field is an Address2 field, determines that it would be highly unlikely for the preceding field to be anything other than an Address field. The target assignment for an element is one that maximizes the probability of the label, together with the probability of the most likely assignment of all previous labels.

Techniques of the present disclosure may also be useful for an application where it is expected to have information from sequencing of things. For example, in text to text-no speech to text applications (e.g., auto-captioning engines), the system of the present disclosure may utilize an assignment module that only analyzes sounds in isolation to determine a set of likely words, but then utilizes a sequence assignment module that, based on a previous word and a model of how often certain words follow other certain words, may select the most likely sequence. Another application of techniques of the present disclosure may be a predictive text autocomplete or autocorrect function. For example, if a user mistypes something, an assignment module may determine a set of possible correct spellings, and the sequence assignment module may determine the correct autocorrect word based on a previous word and a model of how often certain words follow other certain words. Such applications, thus, may be based on exactly this type of Markov model, where once a determination is made at step N, the path may be traversed backwards to improve the previous predictions. In an autocorrect example, a word may have been corrected to “aborigine,” but because a following word (e.g., “potato”) is infrequently observed following “aborigine,” the system of the present disclosure corrects the autocorrect word to “aubergine,” which it has observed is frequently followed by the word “potato.”

Another possible application of the techniques of the present disclosure is itemized item prediction. For example, if a user has lost a receipt, based on items known to be bought and items that have been observed to have been bought together historically, such system may be used to predict which other items are likely to have been on the receipt. Thus, the techniques of the present disclosure may be applied to various situations where meaning may be extracted from sequences of elements. Yet another application may be music prediction. For example, in a room with a lot of background noise, notes may be assigned and then based on a sequence assignment module of observed sequences of notes, the entire sequence of notes may be predicted. Still another application may be audio restoration; for example, some historic music recordings may have missing portions due to cracks or skips in the physical media upon which is was recorded. Based on the local assignment of the sounds and historically observed sequences of sounds, audio missing at the locations of distortion may be predicted using the techniques described.

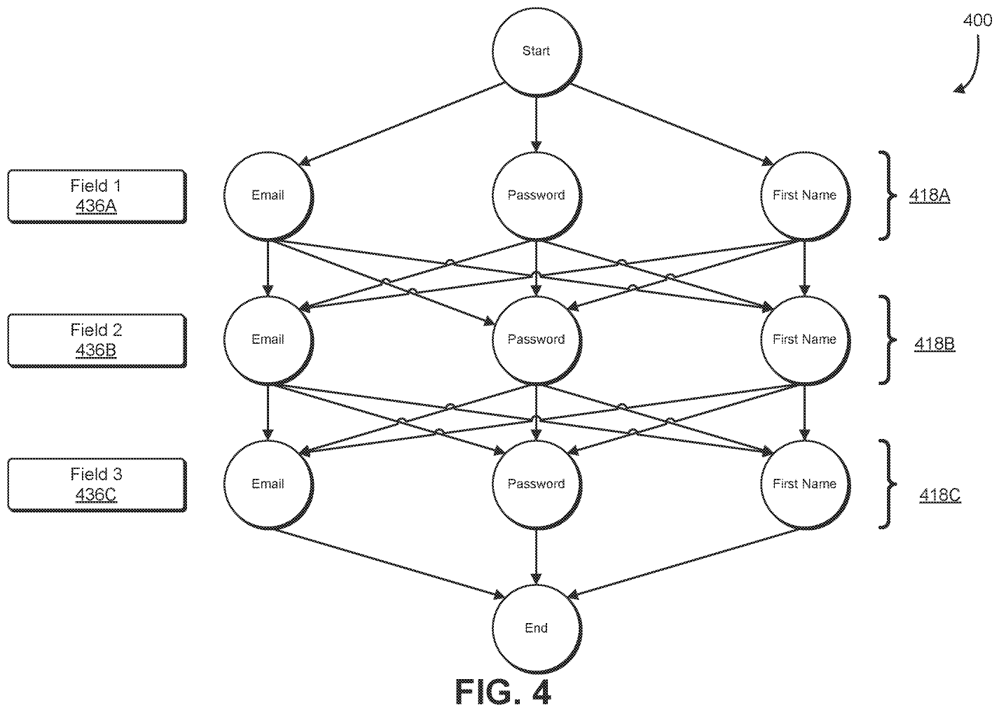

In some embodiments, a client device, such as the client device 130 loads/downloads the form 334. In some of these embodiments, the form is uploaded to a service provider, such as the service provider 142, which extracts the features and identifies elements of interest. In this manner, the client device 130 may be relieved from the need to expend resources (e.g., memory, storage, processor utilization) to determine the features and items of interest. The service provider 142 may then provide the features back to the client device 130 for further processing. In embodiments, the client device 130 may have a trained machine learning model (e.g., the machine learning model 108) that, based on the features, produces a set of confidence scores. In some embodiments, the trained machine learning model executes at the service provider 142, which then provides the set of label confidence scores to the client device 130. Based on sequence information of the predicted elements of interest of the form 334, the sequence assignment module may further determine a more accurate prediction of the elements of interest, as described in FIGS. 4-9. In some embodiments the sequence assignment module is located with the service provide 142, whereas in other embodiments, the sequence assignment module is located on the client device 130.

The elements 302 may be elements of interest in an interface. As depicted in FIG. 3, the elements 302 may be form-fields of an interface. The elements 302 may be any of various elements usable by a user of a client device to enter data. Although depicted as text boxes, it is contemplated that the elements 302 may alternatively include an email field, a number field, a password field, a radio button, a file select control, a text area field, a drop-down box, a combo box, a list box, a multi-select box, or the like. In some embodiments, the elements 302 may be HTML elements.

The form 334 may be a form implemented in an interface accessible by a client device, such as the client device 130 of FIG. 1. For example, the form 334 may be a HTML form on a web page that allows a user to enter data, via the client device, into the form that may be subsequently transmitted to a server of an entity for processing. In embodiments, the form 334 and/or interface may be viewable through a software application, such as a browser, running on the client device. The software application may be provided by another third-party entity. In various embodiments, the executable software code (e.g., JavaScript code) of the form-filling process may be injected by the software application into the source code of the interface (e.g., such as by a plug-in or extension or natively by the software application). In this manner, the form-filling process may have access to examine and extract various features from the interface objects and the interface, transform them into a feature vector or other value or values suitable for input to a trained machine learning model, and/or transmit such data to the machine learning model.

For example, a client device may execute the injected software code comprising the form-filling process to analyze an interface to identify elements of interest. In an embodiment, if the form-filling process detects form-fields that it recognizes (e.g., with a confidence score at a value relative to a threshold, such as meeting or exceeding the threshold), the form-filling process causes the client device to prompt the user (e.g., with a pop-up, such as “Automatically fill in the fields?” in one embodiment). In another embodiment, the form-filling process waits until the user gives focus to one of the input elements, and then the form-filling process determines to prompt the user and/or automatically fill in the input fields. In some embodiments, the form-filling process prompts the user whether to automatically fill in the input fields one by one, whereas in some other the form-filling process prompts the user one time whether to automatically fill in all of the input fields (e.g., all at once).

Note that although the form 334 is depicted in FIG. 3 only with text fields and a submit button, it is contemplated that the techniques of the present disclosure may be implemented with various other form-field classes, such as drop-down boxes, text area boxes, radio buttons, checkboxes, password fields, and the like.

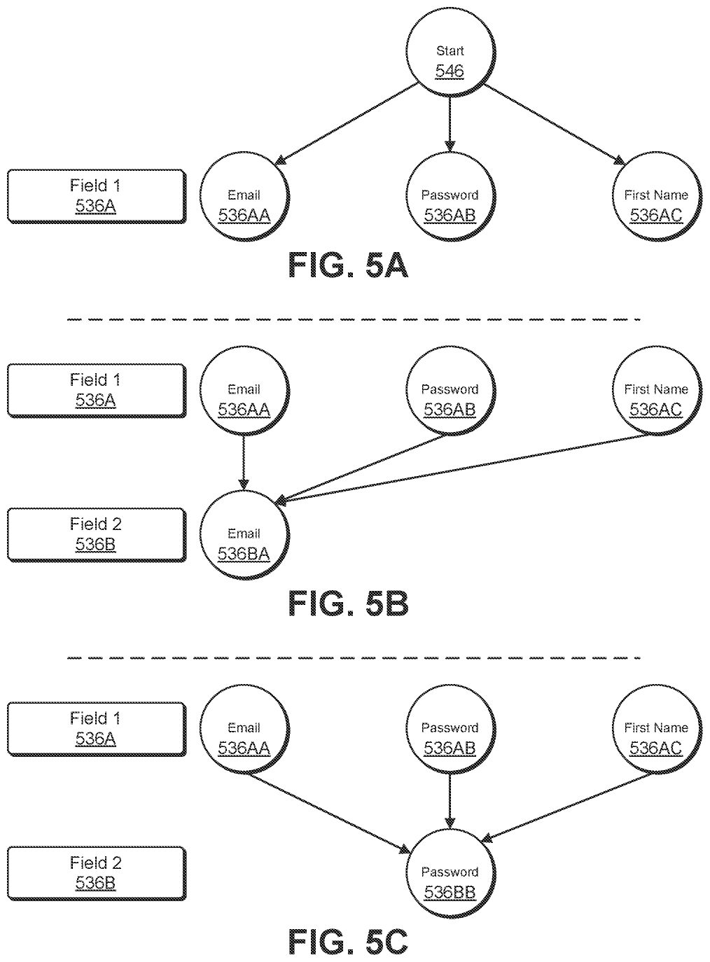

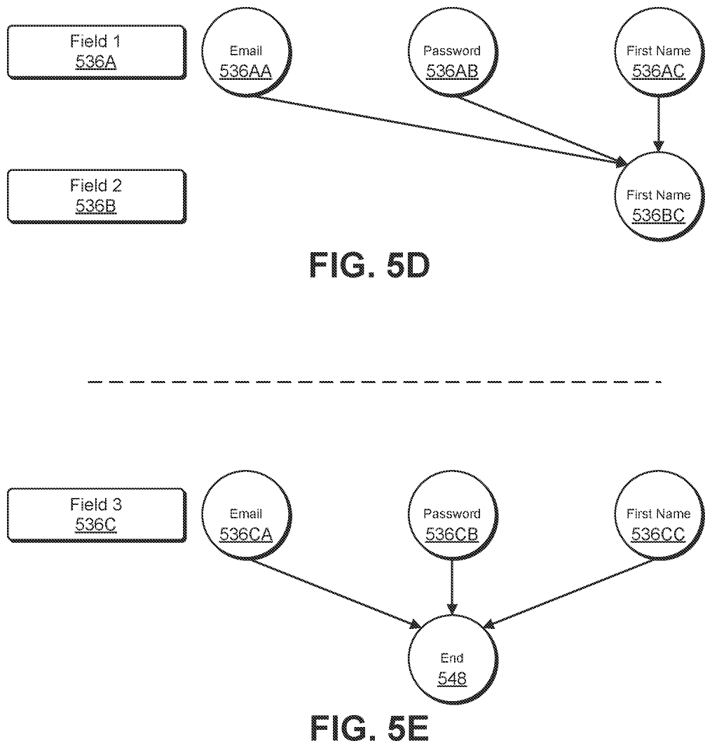

FIG. 4 illustrates an example 400 of element class prediction according to an embodiment of the present disclosure. Specifically, FIG. 4 depicts a set of fields 436A-36C and the possible combinations of element classes 418A-18C. As illustrated in FIG. 4, each of fields 436A-36C has the possibility of being either an email field, a password field, or a first name field. The arrows from start to end represent the paths of all possible combinations of the element classes 418A-18C for the fields 436A-36C. FIGS. 5-7 illustrate the steps performed by an embodiment of the present disclosure for the fields 436-A-36C.

In FIG. 5A, the process begins at the start node 546. In embodiments, the start node does not correspond to a particular element of interest but, rather, is a placeholder that indicates that no elements of interest occur earlier in the sequence. Consequently, the local, isolated probability of the start node 546 may be 1.0 (100%). The probability, then, for first field 536A being an email is the probability of an email element 536AA being the first element of interest in the sequence of elements. Likewise, the probability of the first field 536A being a password field is the probability of a password element 536AB being the first element of interest in the sequence of elements and the probability of the first field 536A being a first name field is the probability of a first name element 536AC being the first element of interest in the sequence of elements. The confidence scores of each of the elements 536AB-36AC being the correct element class for the first field 536A may be calculated based on the local confidence scores generated by a local assignment module, such as the local assignment module 104 of FIG. 1, which may use a naïve Bayes classifier for determining the confidence scores, for the first field 536A combined with a sequence confidence score of the respective element being preceded by the start node 546 (as determined by a sequence assignment module such as the sequence assignment module 110).

In FIG. 5B, the process continues for a second field 536B in a similar manner as with FIG. 5A, except that rather than the preceding node for each of the element classes being the start node 546, the preceding nodes for each possible element class of the second field 536B are each of the possible element classes of the first field 536A. For example, for the probability of the second field 536B being an email field may be determined by finding the maximal probability when the probability of the features of the second field 536B being an email field is combined with the confidence scores of the email element 536BA being preceded by each of the email element 536AA, the password element 536AB, or the first name element 536AC (seq: email→email; password→email; firstname→email).

In FIG. 5C, the process continues for the second field 536B, but now for the next possible element class, the password element 536BB. For example, for the probability of the second field 536B being a password field may be determined by finding the maximal probability when the probability of the features of the second field 536B being a password field is combined with the confidence scores of the password element 536BB being preceded by each of the email element 536AA, the password element 536AB, or the first name element 536AC (seq: email→password; password→password; firstname→password).

In FIG. 5D, the process continues for the second field 536B—but now for the next possible element class—the first name element 536BC. For example, for the probability of the third field 536C being a first name field may be determined by finding the maximal probability when the probability of the features of the third field 536C being a first name field is combined with the confidence scores of the first name element 536BC being preceded by each of the email element 536AA, the password element 536AB, or the first name element 536AC (seq: email→firstname; password→firstname; firstname→firstname).

The process for the third field 536C (see the third field 436C of FIG. 4) is performed in a similar manner to the processes shown in FIGS. 5B-5D, so for brevity those will not be repeated. Note, however, that in various embodiments, the sequence confidence scores are only looked at in pairs (i.e., the current and immediately preceding element in the sequence) for efficiency, and not all the way back to the start node 546. In practice, the number of possible field classes could number in the hundreds or thousands, and determining the sequence confidence scores for each possible combination could require an exponential increase in resource utilization at each succeeding level. However, only considering the possible combinations between the current element of interest and the immediately preceding element of interest provides the benefit of efficient use of resources while maintaining satisfactory accuracy. It is contemplated, however, that considering sequence confidence scores for a fixed number of levels other than two (such as three—the current element of interest, and the preceding two elements of interest in the sequence) could provide increased accuracy, and the resource utilization may not necessarily detract from the user experience.

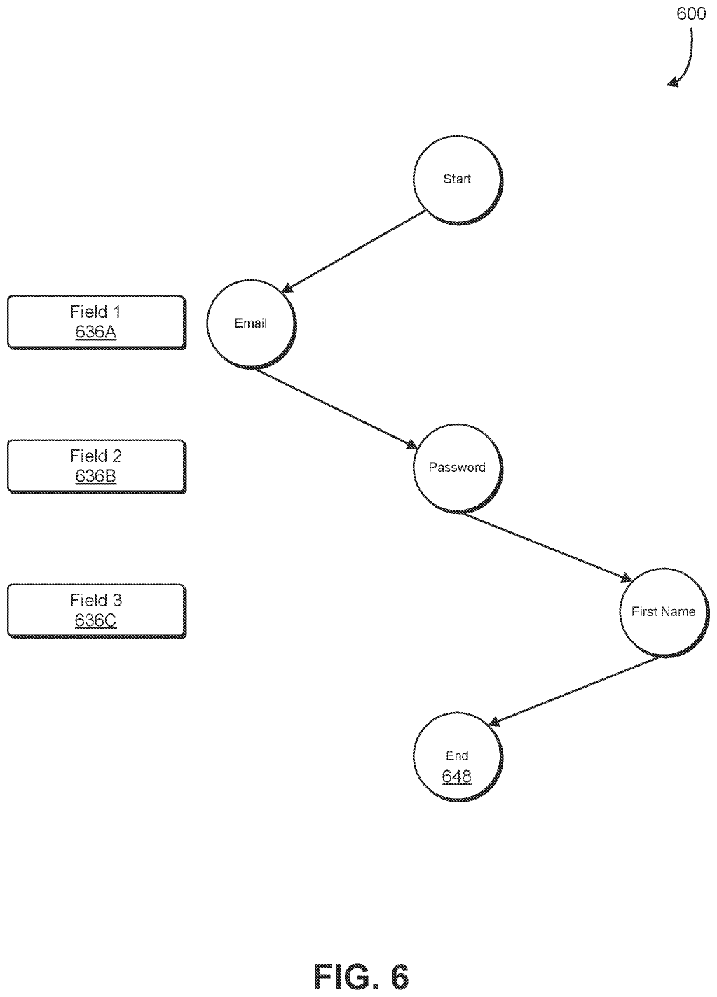

FIG. 5E illustrates the final step of this portion of the process. Here, we have reached the end node 548, which, like the start node 546, does not correspond to a particular element of interest but, rather, is a placeholder that indicates that no elements of interest remain in the sequence. Upon reaching the end node 548, the process may traverse back to the start node 546 to make any corrections to the predictions as needed. For example, at the end node 548, we may evaluate in combination with the previous predicted confidence scores, for each possible element class 536CA-36CC for the third field 536C, the probability of that element class being the last element of interest in the sequence of elements. And then for the second field 536B the probability of that element class being followed by the selected element class for the third field 536C, and so on. This is further illustrated in FIGS. 6-9.

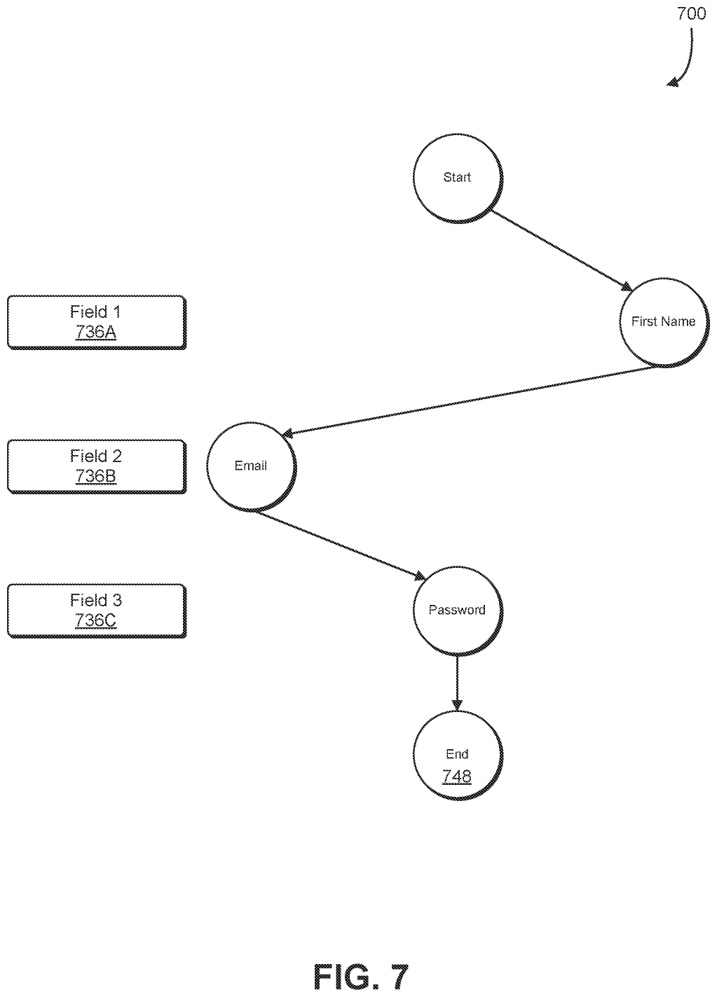

In FIG. 6, the process 600 illustrated in FIGS. 5A-5D is followed for an example similar to the example 400 of FIG. 4, yielding the determination that the first field 636A is an email field, the second field 636B is a password field, and the third field 636 is a first name field. However, upon reaching the end node 648, and upon traversing back, if the system determines that a first name field is unlikely to be a last field in the sequence of elements, the system may correct the classification assignment of the third field 636 in the manner described below and illustrated for FIG. 7.

FIG. 7 illustrates the corrections made to the field element predictions. In FIG. 7, the process 700, having reached the end node 748, determines that a password field, rather than first name field as determined in the first part of the process 600 of FIG. 6, is more likely to be the last element of interest in the sequence, and so changes its prediction for the third field 736C to be a password field. However, doing so results in the process 700 determining that the second field 736B is unlikely to be succeeded by another password field, as had been predicted by the process 600, and so recalculates the confidence scores for the second field 736B and selects an email field as being the most likely element class. This, in turn, results in the determination that the first field 736A is unlikely to be two email fields in a row, and the system re-calculates the confidence scores and selects a first name field as the most likely candidate for the first field 736A.

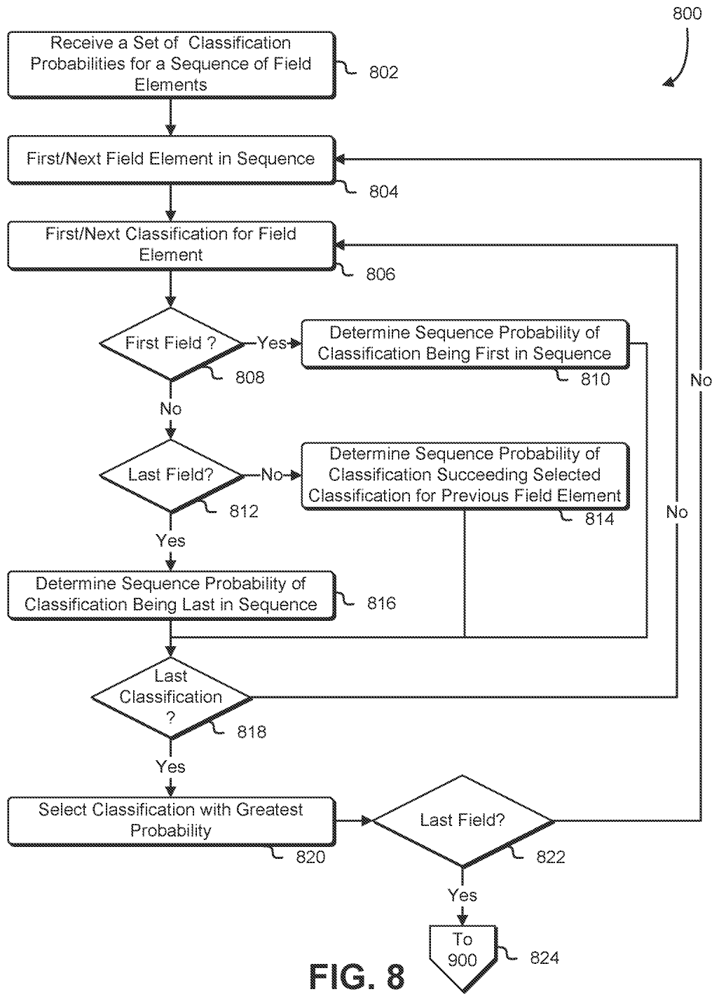

FIG. 8 is a flowchart illustrating an example of a process 800 for element classification in accordance with various embodiments. Some or all of the process 800 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 800 may be performed by any suitable system, such as the computing device 1000 of FIG. 10. The process 800 includes a series of operations where, for each element of interest in a sequence of elements of interest and for each possible classification of the element, the probability of the possible classification following a predicted classification for a previous element in the sequence is maximized. The process 800 is similar to the process described in conjunction with FIGS. 4-6.

In 802, the system performing the process 800 obtains a set of classification confidence scores for each element of a sequence of elements of interest. Each set of classification confidence scores may be a set of label confidence scores where a probability is given for each possible classification that indicates a probability of the element being the respective classification. Such confidence scores may be generated by a local assignment module similar to the local assignment module 104 of FIG. 1.

In 804, the system performing the process 800 begins to iterate through the sequence of elements of interest. Then, in 806, the system begins to iterate through each of the possible classifications for the current element. In 808-16, the system utilizes a sequence assignment module similar to the sequence assignment module 110 of FIG. 1.

In 808, the system performing the process 800 determines if the current element is the first element in the sequence of elements of interest. In some embodiments, this may be determined by the preceding element being a “start” node, as described in FIGS. 4-6. If the current element is a first element in the sequence, the system may proceed to 810, whereupon the system may determine a probability of the currently selected possible classification corresponding to a first element in a sequence of elements of interest.

Otherwise, if the currently selected element is not the first element in the sequence, the system proceeds to 812, whereupon the system may determine whether the current element is the last element in the sequence. In some embodiments, this may be because the node following the current element is an “end” node, as described in FIGS. 4-8. If the currently selected element is the last element in the sequence, the system may proceed to 814, whereupon the system may determine a probability of the currently selected possible classification corresponding to a last element in a sequence of elements.

Otherwise, if the currently selected element is not the last element in the sequence, the system performing the process 800 may proceed to 816, whereupon the system may determine a probability of the currently selected possible classification corresponding to a selected classification for the previous element in a sequence of elements of interest. In 818, the system performing the process 800 determines whether there are further possible classifications for the currently selected element. If so, the system may return to 806 to repeat 806-16 for the next possible classification. Otherwise, the system may proceed to 820.

In 820, the system performing the process 800 may combine/fuse the confidence scores associated with the different possible classifications of the currently selected element in a manner as described in the present disclosure, such as those discussed in conjunction with the probability fusion module 128 of FIG. 1. In 822, the system performing the process 800 determines whether there are further elements in the sequence of elements of interest to process. If so, the system may return to 804 to select the next element in the sequence. If not, the system may proceed to 824.

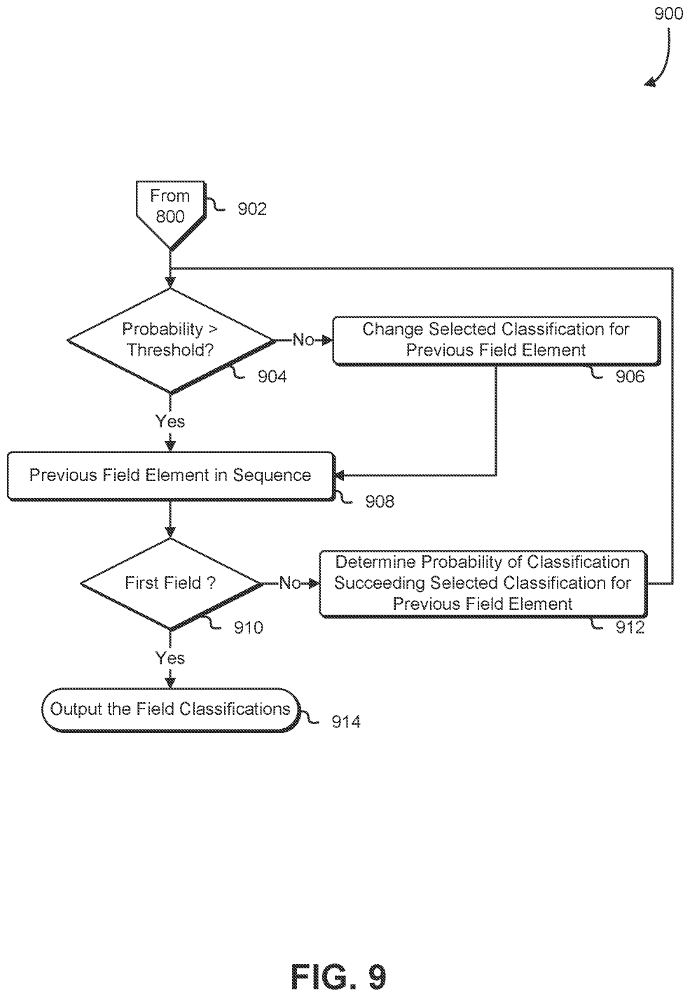

In some embodiments, the process 800 ends at 824. However, in other embodiments, in 824, the system performing the process 800 proceeds to the process 900 of FIG. 9 to perform a validation of the predicted element classes of the sequence and make adjustments as needed. Note that one or more of the operations performed in 802-20 may be performed in various orders and combinations, including in parallel.

FIG. 9 is a flowchart illustrating an example of a process 900 for classification correction in accordance with various embodiments. Some or all of the process 900 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 900 may be performed by any suitable system, such as the computing device 1000 of FIG. 10. The process 900 includes a series of operations wherein the system iterates through a sequence of elements of interest after the classifications have been initially assigned by a process such as the process 800 of FIG. 8 and adjusts any classifications determined to be too improbable.

In 902, the system performing the process 900 begins by continuing from 824 in FIG. 800. In 904, system determines whether the classification assigned to the currently selected element of a sequence of elements of interest (which, if continued from 824, would be the last element of the sequence of elements of interest) is sufficiently probable (e.g., combined sequence and classification confidence scores at a value relative to—e.g., at or above—a threshold). If not, the system performing the process 900 may proceed to 906.

In 906, the system performing the process 900 determines a different classification for the previous element of interest. For example, if the currently selected element is an end node and the selected classification for the previous field element is unlikely to occur at the end of a sequence of elements of interest, such as described in conjunction with FIG. 6, the selected classification for the previous field element may be changed, such as in the manner described in conjunction with FIG. 7. In some implementations, the classification may be changed to the next most probable classification to the selected one, as determined in 806-16 of FIG. 8.

Changing one selected classification, however, may affect the confidence scores of the other selected classifications for the elements in the sequence of elements of interest. Consequently, in 908, the system performing the process 900 may move up the sequence to the previous element. In 910, the system determines whether the selected element is back to the first element in the sequence (e.g., previous element to the currently selected element is a start node). If not, the system may proceed to 912.

In 912, the system performing the process 900 redetermines a probability of the classification (which may or may not have been changed in 906) of the currently selected element being preceded by the selected classification of the element previous in the sequence to the currently selected element of the sequence of elements of interest. This probability may be generated by combining/fusing the probability associated with the local features of the element (such as may be output by the local assignment module 104 of FIG. 1) with the sequence probability of the preceding selected classification following the current classification such as may occur in 820 of FIG. 8. Thereafter, the system may return to 904 to determine if this probability is at a value relative to the threshold.

Otherwise, if the system performing the process 900 has iterated back to the first element in the sequence of elements of interest, in 914, the system may output the classifications determined via the processes 800 and 900 of FIGS. 8 and 9 for the elements of the sequence of elements of interest. In some embodiments, the system may autofill form-fields according to their classification by these processes. Note that one or more of the operations performed in 902-14 may be performed in various orders and combinations, including in parallel.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmission of data, calculations, etc.) denotes that the instructions are being executed by a machine, thereby causing the machine to perform the specified operations.

FIG. 10 is an illustrative, simplified block diagram of a computing device 1000 that can be used to practice at least one embodiment of the present disclosure. In various embodiments, the computing device 1000 includes any appropriate device operable to send and/or receive requests, messages, or information over an appropriate network and convey information back to a user of the device. The computing device 1000 may be used to implement any of the systems illustrated and described above. For example, the computing device 1000 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 1000 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 10, the computing device 1000 may include one or more processors 1002 that, in embodiments, communicate with and are operatively coupled to a number of peripheral subsystems via a bus subsystem. In some embodiments, these peripheral subsystems include a storage subsystem 1006, comprising a memory subsystem 1008 and a file/disk storage subsystem 1010, one or more user interface input devices 1012, one or more user interface output devices 1014, and a network interface subsystem 1016. Such storage subsystem 1006 may be used for temporary or long-term storage of information.

In some embodiments, the bus subsystem 1004 may provide a mechanism for enabling the various components and subsystems of computing device 1000 to communicate with each other as intended. Although the bus subsystem 1004 is shown schematically as a single bus, alternative embodiments of the bus subsystem utilize multiple buses. The network interface subsystem 1016 may provide an interface to other computing devices and networks. The network interface subsystem 1016 may serve as an interface for receiving data from and transmitting data to other systems from the computing device 1000. In some embodiments, the bus subsystem 1004 is utilized for communicating data such as details, search terms, and so on. In an embodiment, the network interface subsystem 1016 may communicate via any appropriate network that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 1016 is enabled by wired and/or wireless connections and combinations thereof.

In some embodiments, the user interface input devices 1012 includes one or more user input devices such as a keyboard; pointing devices such as an integrated mouse, trackball, touchpad, or graphics tablet; a scanner; a barcode scanner; a touch screen incorporated into the display; audio input devices such as voice recognition systems, microphones; and other types of input devices. In general, use of the term “input device” is intended to include all possible types of devices and mechanisms for inputting information to the computing device 1000. In some embodiments, the one or more user interface output devices 1014 include a display subsystem, a printer, or non-visual displays such as audio output devices, etc. In some embodiments, the display subsystem includes a cathode ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 1000. The one or more user interface output devices 1014 can be used, for example, to present user interfaces to facilitate user interaction with applications performing processes described and variations therein, when such interaction may be appropriate.

In some embodiments, the storage subsystem 1006 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 1006. These application modules or instructions can be executed by the one or more processors 1002. In various embodiments, the storage subsystem 1006 additionally provides a repository for storing data used in accordance with the present disclosure. In some embodiments, the storage subsystem 1006 comprises a memory subsystem 1008 and a file/disk storage sub system 1010.

In embodiments, the memory subsystem 1008 includes a number of memories, such as a main random access memory (RAM) 1018 for storage of instructions and data during program execution and/or a read only memory (ROM) 1020, in which fixed instructions can be stored. In some embodiments, the file/disk storage subsystem 1010 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 1000 includes at least one local clock 1024. The at least one local clock 1024, in some embodiments, is a counter that represents the number of ticks that have transpired from a particular starting date and, in some embodiments, is located integrally within the computing device 1000. In various embodiments, the at least one local clock 1024 is used to synchronize data transfers in the processors for the computing device 1000 and the subsystems included therein at specific clock pulses and can be used to coordinate synchronous operations between the computing device 1000 and other systems in a data center. In another embodiment, the local clock is a programmable interval timer.

The computing device 1000 could be of any of a variety of types, including a portable computer device, tablet computer, a workstation, or any other device described below. Additionally, the computing device 1000 can include another device that, in some embodiments, can be connected to the computing device 1000 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 1000 for processing. Due to the ever-changing nature of computers and networks, the description of the computing device 1000 depicted in FIG. 10 is intended only as a specific example for purposes of illustrating the preferred embodiment of the device. Many other configurations having more or fewer components than the system depicted in FIG. 10 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 1000 may include any appropriate hardware, software and firmware for integrating with a data store as needed to execute aspects of one or more applications for the computing device 1000 to handle some or all of the data access and business logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 1000 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 1000 may provide access to content including, but not limited to, text, graphics, audio, video, and/or other content that is provided to a user in the form of HyperText Markup Language (HTML), Extensible Markup Language (XML), JavaScript, Cascading Style Sheets (CSS), JavaScript Object Notation (JSON), and/or another appropriate language. The computing device 1000 may provide the content in one or more forms including, but not limited to, forms that are perceptible to the user audibly, visually, and/or through other senses. The handling of requests and responses, as well as the delivery of content, in an embodiment, is handled by the computing device 1000 using PHP: Hypertext Preprocessor (PHP), Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 1000 typically will include an operating system that provides executable program instructions for the general administration and operation of the computing device 1000 and includes a computer-readable storage medium (e.g., a hard disk, random access memory (RAM), read only memory (ROM), etc.) storing instructions that if executed (e.g., as a result of being executed) by a processor of the computing device 1000 cause or otherwise allow the computing device 1000 to perform its intended functions (e.g., the functions are performed as a result of one or more processors of the computing device 1000 executing instructions stored on a computer-readable storage medium).

In an embodiment, the computing device 1000 operates as a web server that runs one or more of a variety of server or mid-tier applications, including Hypertext Transfer Protocol (HTTP) servers, FTP servers, Common Gateway Interface (CGI) servers, data servers, Java servers, Apache servers, and business application servers. In an embodiment, computing device 1000 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, JavaScript, or TCL, as well as combinations thereof. In an embodiment, the computing device 1000 is capable of storing, retrieving, and accessing structured or unstructured data. In an embodiment, computing device 1000 additionally or alternatively implements a database, such as one of those commercially available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (especially in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments will become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A computer-implemented method, comprising:
determining, based on a document object model (DOM) of a web page, a sequence of form elements in the web page, wherein the sequence includes a first form element that immediately precedes a second form element in the sequence;
obtaining a first set of potential classifications for the first form element;
obtaining a set of local confidence scores for a second set of potential classifications of the second form element, the set of local confidence scores being based on one or more features of the second form element;
obtaining a set of sequence confidence scores by obtaining, for each second potential classification of the second set of potential classifications, confidence scores indicating a probability of the second potential classification being immediately preceded in sequence by each first potential classification of the first set of potential classifications;
determining, based on the set of local confidence scores of the first form element and the set of sequence confidence scores, a classification assignment for the second form element; and
filling the second form element in accordance with the classification assignment.

2. The computer-implemented method of claim 1, wherein determining the classification assignment includes obtaining the classification assignment from a naïve Bayes network model as a result of providing the set of local confidence scores and the set of sequence confidence scores to the naïve Bayes network model as input.

3. The computer-implemented method of claim 1, further obtaining the set of local confidence scores includes determining the set of local confidence scores based on HyperText Markup Language attributes of the second form element.

4. The computer-implemented method of claim 1, further including as a result of determining, based on the classification assignment for the second form element, that an assigned classification for the first form element is improbable, assigning a different classification to the first form element.

5. A system, comprising:
one or more processors; and
memory including computer-executable instructions that, if executed by the one or more processors, cause the system to:
determine a sequence of interface elements in an interface, wherein the sequence includes a first element that immediately precedes a second element in the sequence;
obtain a first set of potential classifications for the first element;
obtain a set of local confidence scores for a second set of potential classifications of the second element;
obtain a set of sequence confidence scores by obtaining, for each second potential classification of the second set of potential classifications, a set of scores indicating probability of the second potential classification being immediately preceded in sequence by each first potential classification of the first set of potential classifications;
determine, based on the set of local confidence scores of the first element and the set of sequence confidence scores, a classification assignment for the second element; and
perform an operation with the second element in accordance with the classification assignment.

6. The system of claim 5, wherein the computer-executable instructions that cause the system to obtain the set of local confidence scores include instructions that cause the system to:
derive a set of features from source code of the second element;
provide, in a format usable by a machine learning model, the set of features to the machine learning model as input; and
obtain, as output from the machine learning model, the set of local confidence scores.

7. The system of claim 5, wherein:
the second element is a form element in the interface; and
the operation is to automatically input characters into the form element.

8. The system of claim 5, wherein:
the computer-executable instructions further cause the system to detect mistyped text being inputted into the second element by a user; and
the computer-executable instructions that cause the system to perform the operation cause the system to autocorrect the mistyped text with predicted text.

9. The system of claim 5, wherein the second element is a HyperText Markup Language element.

10. The system of claim 5, wherein the computer-executable instructions further include instructions that further cause the system to as a result of a determination, based on a subsequent classification assignment of a third element in the sequence, that the classification assignment is unlikely, modify the classification assignment.

11. The system of claim 5, wherein the computer-executable instructions that cause the system to obtain the first set of potential classifications include instructions that further cause the system to obtain the first set of potential classifications from a probabilistic classifier capable of computing conditional probability.

12. The system of claim 11, wherein the probabilistic classifier is a naïve Bayes classifier.

13. A non-transitory computer-readable storage medium having stored thereon executable instructions that, if executed by one or more processors of a computer system, cause the computer system to at least:
determine a sequence of HyperText Markup Language (HTML) elements in an interface, wherein the sequence includes a first HTML element class that immediately precedes a second HTML element class in the sequence;
obtain a first set of potential classifications for the first HTML element class;
obtain a set of local confidence scores for a second set of potential classifications of the second HTML element class;
obtain a set of sequence confidence scores by obtaining a confidence scores of each second potential classification of the second set of potential classifications being immediately preceded in sequence by each first potential classification of the first set of potential classifications;
determine, based on the set of local confidence scores of the first HTML element class and the set of sequence confidence scores, a classification assignment for the second HTML element class; and
perform an operation with the second HTML element class in accordance with the classification assignment.

14. The non-transitory computer-readable storage medium of claim 13, wherein the executable instructions that cause the computer system to determine the sequence of HTML elements include instructions that cause the computer system to traverse a tree structure of a document object model of the interface to determine the sequence.

15. The non-transitory computer-readable storage medium of claim 13, wherein the executable instructions that cause the computer system to obtain the set of local confidence scores include instructions that cause the computer system to:
identify a set of features of the second HTML element class;
input the set of features into a machine learning model trained to determine confidence scores of classifications of HTML element classes based on HTML element attributes; and
obtain, as output from the machine learning model, the set of local confidence scores.

16. The non-transitory computer-readable storage medium of claim 13, wherein the executable instructions that cause the computer system to obtain the set of sequence confidence scores further include instructions that further cause the computer system to:
access a data store that includes previously observed form classification sequences; and
determine a probability of the second potential classification being immediately preceded by the first potential classification.

17. The non-transitory computer-readable storage medium of claim 13, wherein the executable instructions that cause the computer system to determine the classification assignment include instructions that cause the computer system to:
provide the set of local confidence scores and the set of sequence confidence scores as input to a naïve Bayes classifier; and
obtain the classification assignment as output from the naïve Bayes classifier.

18. The non-transitory computer-readable storage medium of claim 13, wherein the executable instructions that cause the computer system to determine the classification assignment include instructions that cause the computer system to:
model the first HTML element class and the second HTML element class in a Markov chain; and
evaluate, using a Viterbi algorithm, the Markov chain using the set of local confidence scores and the set of sequence confidence scores.

19. The non-transitory computer-readable storage medium of claim 13, wherein the first HTML element class is a class of an HTML form element.

20. The non-transitory computer-readable storage medium of claim 19, wherein the executable instructions that cause the computer system to:
identify that a user has modified a value of the HTML form element;
obtain a new set of sequence confidence scores based on the value modified; and
re-determine the classification assignment based on the set of local confidence scores and the new set of sequence confidence scores.
